(19) United States
(12) Patent Application Publication
(10) Pub. No.: US 2019/0322938 A1
(43) Pub. Date: Oct. 24, 2019

(54) LIQUID CRYSTAL MEDIUM MIXTURE, LIQUID CRYSTAL DISPLAY PANEL AND MANUFACTURING METHOD OF LIQUID CRYSTAL DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventor: Song LAN, Shenzhen (CN)

(21) Appl. No.: 16/045,077

(22) Filed: Jul. 25, 2018

Related U.S. Application Data
(63) Continuation of application No. PCT/CN2018/087311, filed on May 17, 2018.

(30) Foreign Application Priority Data
Apr. 20, 2018 (CN) 201810362206.7

(51) Int. Cl. C09K 19/56; G02F 1/1333

(52) U.S. Cl. CPC C09K 19/56; C09K 2019/0448; G02F 1/133365

(57) ABSTRACT

Provided is a liquid crystal medium mixture, comprising liquid crystal molecules, reactive monomers and a vertical alignment agent, and the vertical alignment agent comprises a head group, a middle base group, a tail group, a polymeric group and a polymerization inhibitor functional group; wherein the head group anchors a substrate surface of the LCD panel to achieve vertical alignment of the liquid crystal molecules, and the middle base group and the tail group guide the liquid crystal molecules to be aligned, and the polymeric group forms a layer of polymer particles under irradiation of ultraviolet light to cause pretilt angles of the liquid crystal molecules, and the polymerization inhibitor functional group reduces the reactivity of the polymeric group so that a size distribution of the polymer particles formed by ultraviolet irradiation is uniform to reduce occurrence of broken bright spots and to enhance the ability of anchoring the substrate surface.

### CROSS-REFERENCE TO RELATED APPLICATION

This application is a continuing application of PCT Patent Application No. PCT/CN2018/087311 entitled “Liquid crystal medium mixture, liquid crystal display panel and manufacturing method of liquid crystal display panel”, filed on May 17, 2018, which claims priority to Chinese Patent Application No. 201810362206.7, filed on Apr. 20, 2018, both of which are hereby incorporated in its entireties by reference.

### FIELD OF THE INVENTION

The present invention relates to a liquid crystal display field, and more particularly to a liquid crystal medium mixture, a liquid crystal display panel and a manufacturing method of a liquid crystal display panel.

### BACKGROUND OF THE INVENTION

The structure of the LCD panel mainly comprises a Thin Film Transistor Array Substrate, a Color Filter substrate and a Liquid Crystal Layer arranged between the two substrates. The working principle is that the light of backlight module is reflected to generate images by applying driving voltages to the two glass substrate for controlling the rotations of the liquid crystal molecules (LC).

In general, a layer of polyimide (PI) alignment material needs to be sprayed on surfaces of the upper and lower substrates of the liquid crystal display panel, which are mainly for guiding the alignment of the liquid crystal molecules. However, the PI alignment material has the following disadvantages: 1, the PI alignment material is expensive, and the related equipment for spraying the PI alignment material is also expensive, resulting in an increase in production costs; 2, the PI alignment material usually uses N-methylpyrrolidone (NMP) as a solvent, but it is easy to cause harm to the human body because NMP solvent is not environmentally friendly; 3, in the spraying process of the PI alignment material, due to the problems, such as coating uniformity, non-stickiness and foreign matter, it is easy to cause a loss in the product yield to increase the product cost. Therefore, a display panel that does not print the polyimide alignment material (i.e., the vertical alignment liquid crystal display panel) has gradually become a research hotspot.

In the manufacturing process, the printing process of the PI alignment material is omitted for the upper and lower substrates of the vertical alignment liquid crystal material display panel, and the function of guiding the ordered alignment of the liquid crystal is realized by adding a material having a vertical alignment function in the liquid crystal medium mixture.

However, the vertical alignment liquid crystal material display panel with the liquid crystal layer prepared by a conventional vertical alignment agent has the following problems: on one hand, the ability of the vertical alignment agent anchoring on the substrate surface of the liquid crystal display panel needs to be improved, and the liquid crystal diffusibility needs to be increased to further reduce the occurrence probability of color aberration; on the other hand, the polymer particles formed by the vertical alignment agent are large and non-uniform, which is easy to cause the worse stability of the liquid crystal alignment to cause the phenomenon of light leakage in the dark state in the liquid crystal display panel and the lower reliability of the liquid crystal display panel.

### SUMMARY OF THE INVENTION

An objective of the present invention is to provide a liquid crystal medium mixture, a liquid crystal display panel and a manufacturing method of a liquid crystal display panel. By improving the anchoring ability of the vertical alignment agent in the liquid crystal layer and the uniformity of the polymer particles formed by the polymerization under UV irradiation, the alignment stability of the liquid crystal can be improved to avoid the phenomenon of light leakage in the dark state in the liquid crystal display panel to raise the reliability of the liquid crystal display panel.

For solving the aforesaid technical issues, the embodiment of the present invention provides a liquid crystal medium mixture, disposed in a liquid crystal layer of a liquid crystal display panel, wherein the liquid crystal medium mixture comprises liquid crystal molecules, reactive monomers and a vertical alignment agent, and the vertical alignment agent comprises a head group, a middle base group, a tail group, a polymeric group and a polymerization inhibitor functional group;

wherein a constitutional formula of the vertical alignment agent is one of

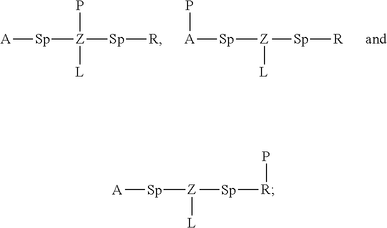

wherein

A refers to a head group for anchoring a surface of a substrate of the liquid crystal display panel to achieve vertical alignment of the liquid crystal molecules, and a structure thereof is represented as a composition containing a plurality of oxygen atoms;

Sp refers to a rigid link for guiding alignment of the liquid crystal molecules, and a structure thereof is represented as —(CH₂)i-, and i is 1 to 8; CH₂ of any one middle end of Sp can be replaced by —O—, —S—, —CO—, —CO—O—, —O—CO—, —O—CO—O—, —OCH₂—, —CH₂O—, —CH═CH—, —CF═CF—, —CH═CH—COO— or —OCO—CH═CH—;

Z refers to a middle base group for guiding arrangement of the liquid crystal molecules, and a structure thereof is represented as [A]m, and m is an integer larger than 1; wherein A is represented as a benzene ring or a cycloalkane, and one or more H atom of the benzene ring or the cycloalkane can be replaced by F, Cl, Br, I, —CN, —NO₂ or —C(═O)H;

R refers to a tail group for guiding arrangement of the liquid crystal molecules, and a structure thereof is represented as a linear or branched alkane having 5 to 20 C atoms; wherein any one CH₂ group of R can be replaced by a group of phenyl, cycloalkyl, —CONH—, —COO—, —O—CO—, —S—, —CO— or —CH═CH—, and the H atom can be replaced by a group of F or Cl;

P refers to a polymeric group that forms a film layer of polymer particles under irradiation of ultraviolet light so that the liquid crystal molecules have a pretilt angle, and a structure thereof is represented as an any combination of

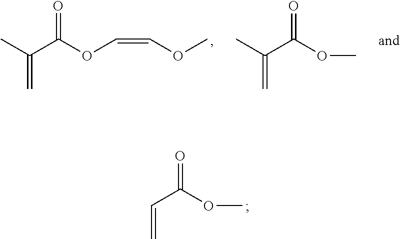

L refers to a polymerization inhibitor functional group for reducing an reactivity of the polymeric group P so that a size distribution of polymer particles formed under irradiation of ultraviolet light is uniform and for further enhancing an ability to anchor the surface of the substrate of the liquid crystal display panel, and a structure thereof is represented as phenol, and a specific constitutional formula is

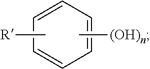

wherein n is 1 to 2; R′ is represented as a linear or branched alkane having 1 to 5 carbon atoms, wherein any one carbon atom of R′ can be replaced by —O—, —CO—, —COO— or —O—CO—.

A structure of the polymerization inhibitor functional group is represented by one of

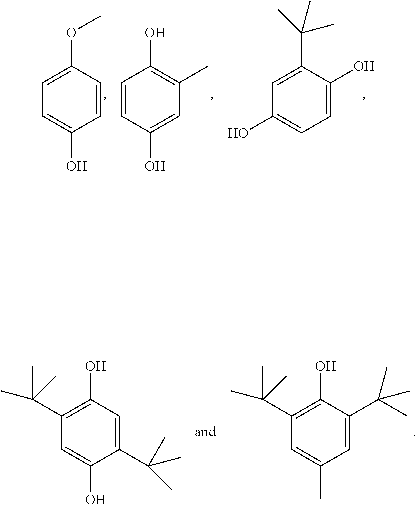

A mass percentage relationship of the liquid crystal molecules, the active monomers and the vertical alignment agent is 0.2 to 0.5%: 0.2 to 5.0%: 94.5 to 99.6%.

A structure of the vertical alignment agent is one or more of following compounds:

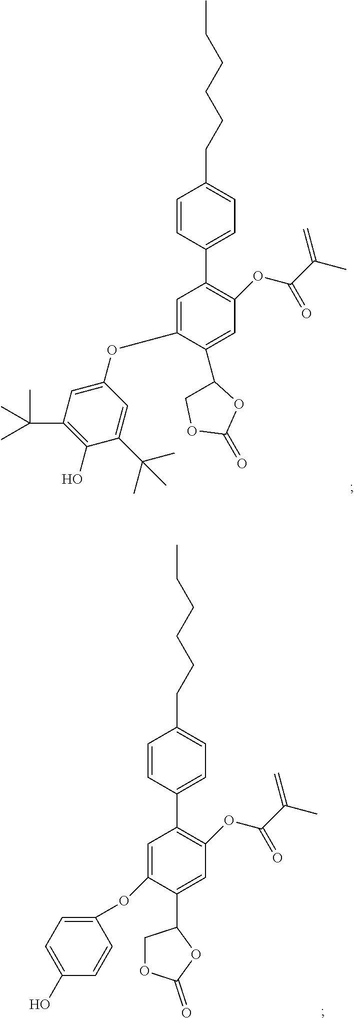 [SMILES: C=C(C)C(=O)Oc1cc(C2COC(=O)O2)c(Oc2cc(C(C)(C)C)c(O)c(C(C)(C)C)c2)cc1-c1ccc(CCCCCC)cc1 ; ";" ; C=C(C)C(=O)Oc1cc(C2COC(=O)O2)c(Oc2ccc(O)cc2)cc1-c1ccc(CCCCCC)cc1 ; ";"]

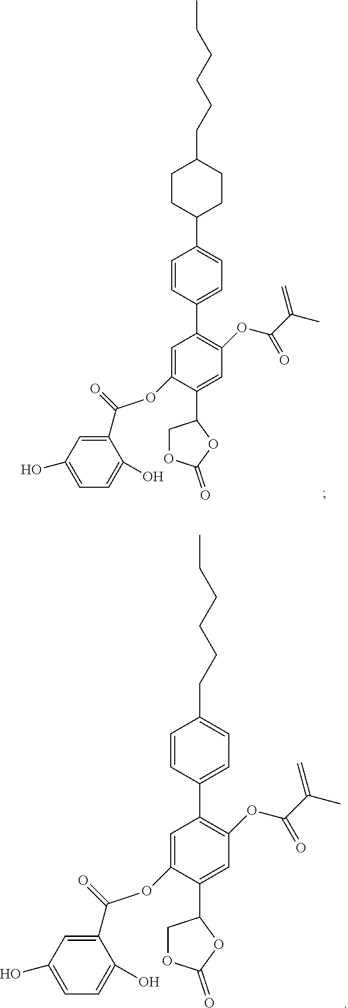

Correspondingly, the embodiment of the present invention further provides a liquid crystal display panel, comprising a thin film transistor array substrate, a color filter substrate and a liquid crystal layer configured between the thin film transistor array substrate and the color filter substrate, wherein the liquid crystal layer comprises a liquid crystal medium mixture;

the liquid crystal medium mixture comprises liquid crystal molecules, reactive monomers and a vertical alignment agent, and the vertical alignment agent comprises a head group, a middle base group, a tail group, a polymeric group and a polymerization inhibitor functional group;

wherein a constitutional formula of the vertical alignment agent is one of

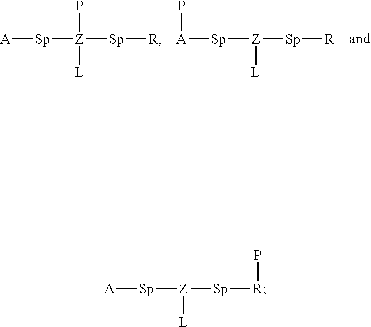

wherein

A refers to a head group for anchoring a surface of a substrate of the liquid crystal display panel to achieve vertical alignment of the liquid crystal molecules, and a structure thereof is represented as a composition containing a plurality of oxygen atoms;

Sp refers to a rigid link for guiding alignment of the liquid crystal molecules, and a structure thereof is represented as —(CH₂)i-, and i is 1 to 8; CH₂ of any one middle end of Sp can be replaced by —O—, —S—, —CO—, —CO—O—, —O—CO—, —O—CO—O—, —OCH₂—, —CH₂O—, —CH═CH—, —CF═CF—, —CH═CH—COO— or —OCO—CH═CH—;

Z refers to a middle base group for guiding arrangement of the liquid crystal molecules, and a structure thereof is represented as [A]m, and m is an integer larger than 1; wherein A is represented as a benzene ring or a cycloalkane, and one or more H atom of the benzene ring or the cycloalkane can be replaced by F, Cl, Br, I, —CN, —NO₂ or —C(═O)H;

R refers to a tail group for guiding arrangement of the liquid crystal molecules, and a structure thereof is represented as a linear or branched alkane having 5 to 20 C atoms; wherein any one CH₂ group of R can be replaced by a group of phenyl, cycloalkyl, —CONH—, —COO—, —O—CO—, —S—, —CO— or —CH═CH—, and the H atom can be replaced by a group of F or Cl;

P refers to a polymeric group that forms a film layer of polymer particles under irradiation of ultraviolet light so that the liquid crystal molecules have a pretilt angle, and a structure thereof is represented as an any combination of

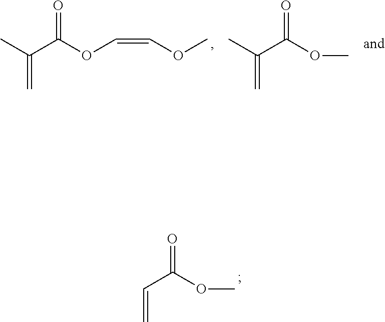

L refers to a polymerization inhibitor functional group for reducing an reactivity of the polymeric group P so that a size distribution of polymer particles formed under irradiation of ultraviolet light is uniform and for further enhancing an ability to anchor the surface of the substrate of the liquid crystal display panel, and a structure thereof is represented as phenol, and a specific constitutional formula is

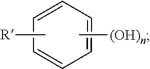

wherein n is 1 to 2; R′ is represented as a linear or branched alkane having 1 to 5 carbon atoms, wherein any one carbon atom of R′ can be replaced by —O—, —CO—, —COO— or —O—CO—.

A structure of the polymerization inhibitor functional group is represented by one of

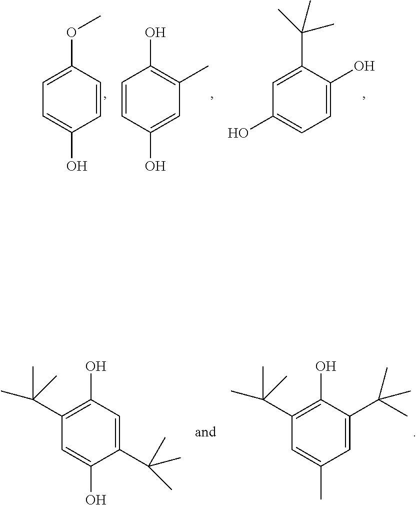

A mass percentage relationship of the liquid crystal molecules, the active monomers and the vertical alignment agent is 0.2 to 0.5%: 0.2 to 5.0%: 94.5 to 99.6%.

A structure of the vertical alignment agent is one or more of following compounds:

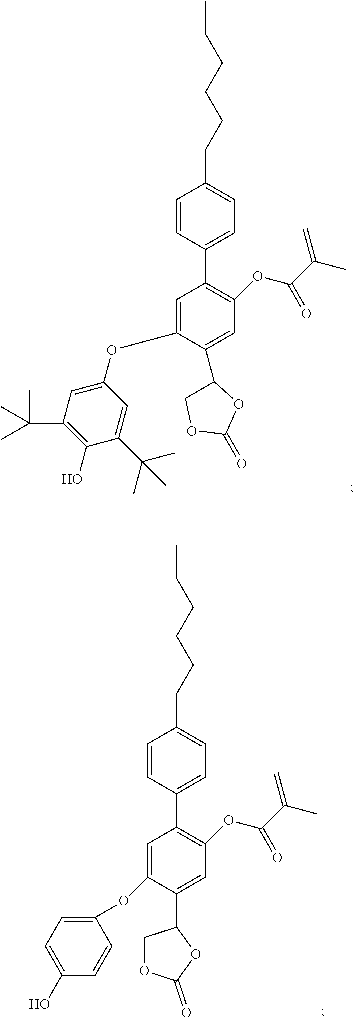 [SMILES: C=C(C)C(=O)Oc1cc(C2COC(=O)O2)c(Oc2cc(C(C)(C)C)c(O)c(C(C)(C)C)c2)cc1-c1ccc(CCCCCC)cc1 ; ";" ; C=C(C)C(=O)Oc1cc(C2COC(=O)O2)c(Oc2ccc(O)cc2)cc1-c1ccc(CCCCCC)cc1 ; ";"]

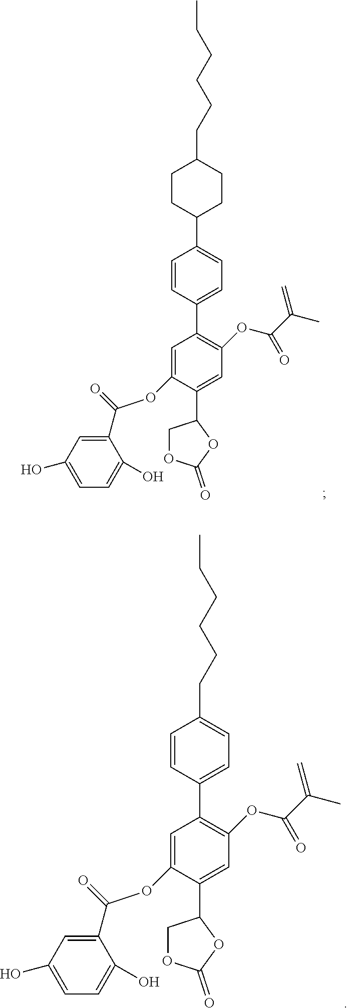

Correspondingly, the embodiment of the present invention further provides a manufacturing method of a liquid crystal display panel, comprising:

Step S1, providing a thin film transistor array substrate, a color filter substrate and a liquid crystal medium mixture; wherein the liquid crystal medium mixture comprises liquid crystal molecules, reactive monomers and a vertical alignment agent, and the vertical alignment agent comprises a head group, a middle base group, a tail group, a polymeric group and a polymerization inhibitor functional group;

wherein a constitutional formula of the vertical alignment agent is one of

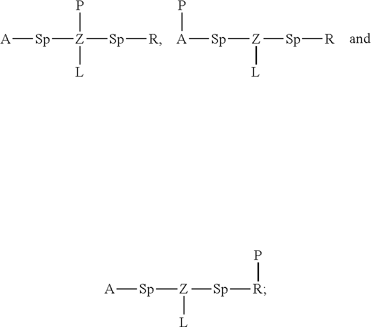

wherein

A refers to a head group for anchoring a surface of a substrate of the liquid crystal display panel to achieve vertical alignment of the liquid crystal molecules, and a structure thereof is represented as a composition containing a plurality of oxygen atoms;

Sp refers to a rigid link for guiding alignment of the liquid crystal molecules, and a structure thereof is represented as —(CH₂)i-, and i is 1 to 8: CH₂ of any one middle end of Sp can be replaced by —O—, —S—, —CO—, —CO—O—, —O—CO—, —O—CO—O—, —OCH₂—, —CH₂O—, —CH═CH—, —CF═CF—, —CH═CH—COO— or —OCO—CH═CH—;

Z refers to a middle base group for guiding arrangement of the liquid crystal molecules, and a structure thereof is represented as [A]m, and m is an integer larger than 1; wherein A is represented as a benzene ring or a cycloalkane, and one or more H atom of the benzene ring or the cycloalkane can be replaced by F, Cl, Br, I, —CN, —NO₂ or —C(═O)H;

R refers to a tail group for guiding arrangement of the liquid crystal molecules, and a structure thereof is represented as a linear or branched alkane having 5 to 20 C atoms; wherein any one CH₂ group of R can be replaced by a group of phenyl, cycloalkyl, —CONH—, —COO—, —O—CO—, —S—, —CO— or —CH═CH—, and the H atom can be replaced by a group of F or Cl;

P refers to a polymeric group that forms a film layer of polymer particles under irradiation of ultraviolet light so that the liquid crystal molecules have a pretilt angle, and a structure thereof is represented as an any combination of

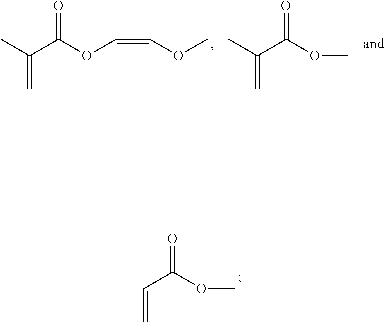

L refers to a polymerization inhibitor functional group for reducing an reactivity of the polymeric group P so that a size distribution of polymer particles formed under irradiation of ultraviolet light is uniform and for further enhancing an ability to anchor the surface of the substrate of the liquid crystal display panel, and a structure thereof is represented as phenol, and a specific constitutional formula is

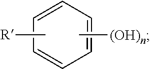

wherein n is 1 to 2; R′ is represented as a linear or branched alkane having 1 to 5 carbon atoms, wherein any one carbon atom of R′ can be replaced by —O—, —CO—, —COO— or —O—CO—;

Step S2, selecting the thin film transistor array substrate or the color filter substrate to be injected into the liquid crystal medium mixture, and injecting the liquid crystal medium mixture into the selected substrate;

Step S3, coating a sealant on a surface of the selected substrate to form a seal frame enclosing the liquid crystal medium mixture in a semi-closed shape, and coating the surface of the selected substrate except the seal frame with a conductive adhesive;

Step S4, assembling and adhering the thin film transistor array substrate and the color filter substrate in a vacuum environment, and curing the sealant of the seal frame so that the liquid crystal medium mixture in the seal frame forms a liquid crystal layer between the thin film transistor array substrate and the color filter substrate; wherein a part of the vertical alignment agent in the liquid crystal medium mixture is adsorbed on the surface of the thin film transistor array substrate or the color filter substrate by the head group thereof, and is vertically aligned on the surface of the thin film transistor array substrate or the color filter substrate to guide the liquid crystal molecules to be vertically aligned, and another part of the vertical alignment agent in the liquid crystal medium mixture is filled in the liquid crystal layer;

Step S5, applying a certain voltage to the liquid crystal layer to deflect the liquid crystal molecules in the liquid crystal medium mixture, and applying ultraviolet light to the liquid crystal layer, in which the liquid crystal molecules are deflected for a certain period of time while continuously applying the certain voltage, so that as the vertical alignment agent filled in the liquid crystal layer is polymerized with the reactive monomers, a polymer film having a uniform particle size distribution is respectively formed on the surfaces of the thin film transistor array substrate and the color filter substrate by utilizing the polymerization inhibitor functional group thereof;

Step S6, removing the continuously applied certain voltage and keeping irradiating the liquid crystal layer, in which the polymer film with the uniform particle size distribution with ultraviolet light for a period of time so that the vertical alignment agent remaining on the surfaces of the thin film transistor array substrate and the color filter substrate all reacts with the reactive monomer, and the polymer film having the uniform particle size distribution is further formed on the surfaces of the thin film transistor array substrate and the color filter substrate, respectively by utilizing the polymerization inhibitor functional group thereof to manufacture the liquid crystal display panel.

In Step S1, a mass percentage relationship of the liquid crystal molecules, the active monomers and the vertical alignment agent is 0.2 to 0.5%:0.2 to 5.0%:94.5 to 99.6%.

In Step S4, a thermal curing or an ultraviolet irradiation curing is implemented to the sealant of the seal frame.

In Step S5, the voltage applied to the liquid crystal layer is 13 to 25V, and an intensity of ultraviolet irradiation used is 85 to 100 mW/cm2, and an irradiation time is 20 to 100 s.

In Step S6, the period of time for the ultraviolet irradiation is 90 to 120 min.

The implementation of the embodiment of the present invention possesses benefits: since the polymerization inhibitor functional group is used in the vertical alignment agent to reduce the reactivity of the polymeric group, the size distribution of the polymer particles formed by the polymerization under UV irradiation is uniform, and the anchoring force to the substrate surface of the liquid crystal display panel is reinforced. Thus, the alignment stability of the liquid crystal can be improved to avoid the phenomenon of light leakage in the dark state in the liquid crystal display panel to raise the reliability of the liquid crystal display panel.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a structural diagram of a liquid crystal medium mixture provided by the first embodiment of the present invention;

FIG. 2 is a flowchart of a manufacturing method of a liquid crystal display panel according to the third embodiment of the present invention;

FIG. 3 is an application diagram of a manufacturing method of a liquid crystal display panel according to the third embodiment of the present invention; wherein a1 is color filter substrate, a2 is vertical alignment agent, a3 is reactive monomer (RM), a4 is liquid crystal molecule, a5 is indium tin oxide film layer, a6 is thin film transistor array substrate and a7 is polymer film layer;

FIG. 4 is a comparison diagram of polymer film layers formed after the liquid crystal layer is manufactured by using different vertical alignment agents in the manufacturing method of the liquid crystal display panel provided by the third embodiment of the present invention.

### DETAILED DESCRIPTION OF PREFERRED EMBODIMENTS

In order to make the objectives, technical solutions, and advantages of the embodiments of the disclosure more apparent, the present invention will be described below in detail with reference to the drawings.

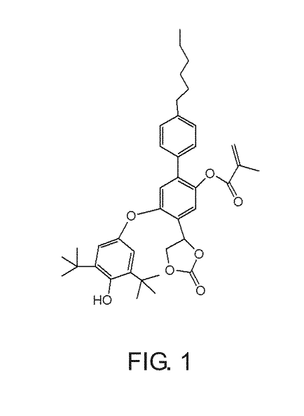

As shown in FIG. 1, in the first embodiment of the present invention, provided is a liquid crystal medium mixture, disposed in a liquid crystal layer of a liquid crystal display panel, wherein the liquid crystal medium mixture comprises liquid crystal molecules 1, reactive monomers 2 and a vertical alignment agent 3, and the vertical alignment agent 3 comprises a head group, a middle base group, a tail group, a polymeric group and a polymerization inhibitor functional group;

wherein a constitutional formula of the vertical alignment agent 3 is one of

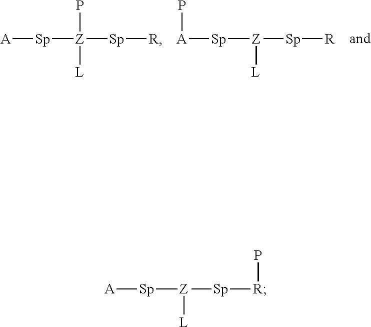

wherein

A refers to a head group for anchoring a surface of a substrate of the liquid crystal display panel to achieve vertical alignment of the liquid crystal molecules 1, and a structure thereof is represented as a composition containing a plurality of oxygen atoms; for instance, the constitutional formula of A is preferable to be

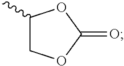

Sp refers to a rigid link for guiding alignment of the liquid crystal molecules 1, and a structure thereof is represented as —(CH₂)i-, and i is 1 to 8; CH₂ of any one middle end of Sp can be replaced by —O—, —S—, —CO—, —CO—O—, —O—CO—, —O—CO—O—, —OCH₂—, —CH₂O—, —CH═CH—, —CF═CF—, —CH═CH—COO— or —OCO—CH═CH—;

Z refers to a middle base group for guiding arrangement of the liquid crystal molecules 1, and a structure thereof is represented as [A]m, and m is an integer larger than 1; wherein A is represented as a benzene ring or a cycloalkane, and one or more H atom of the benzene ring or the cycloalkane can be replaced by F, Cl, Br, I, —CN, —NO₂ or —C(═O)H; for instance, as A is a benzene ring, which is preferable to be

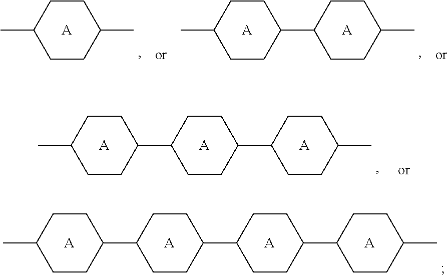

R refers to a tail group for guiding arrangement of the liquid crystal molecules 1, and a structure thereof is represented as a linear or branched alkane having 5 to 20 C atoms; wherein any one CH₂ group of R can be replaced by a group of phenyl, cycloalkyl, —CONH—, —COO—, —O—CO—, —S—, —CO— or —CH═CH—, and the H atom can be replaced by a group of F or Cl;

P refers to a polymeric group that forms a film layer of polymer particles under irradiation of ultraviolet light so that the liquid crystal molecules 1 have a pretilt angle, and a structure thereof is represented as an any combination of

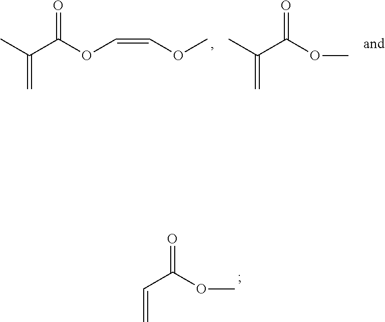

L refers to a polymerization inhibitor functional group for reducing an reactivity of the polymeric group P so that a size distribution of polymer particles formed under irradiation of ultraviolet light is uniform and for further enhancing an ability to anchor the surface of the substrate of the liquid crystal display panel, and a structure thereof is represented as phenol, and a specific constitutional formula is

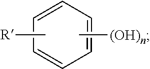

wherein n is 1 to 2; R′ is represented as a linear or branched alkane having 1 to 5 carbon atoms, wherein any one carbon atom of R′ can be replaced by —O—, —CO—, —COO— or —O—CO—.

Significantly, since the polymerization inhibitor functional group L is used in the vertical alignment agent to reduce the reactivity of the polymeric group P, the size distribution of the polymer particles formed by the polymerization under UV irradiation is uniform, and the anchoring force to the substrate surface of the liquid crystal display panel is reinforced. Thus, the amount of the vertical alignment agent 3 can reduced, and the alignment stability of the liquid crystal can be improved to avoid the phenomenon of light leakage in the dark state in the liquid crystal display panel to raise the reliability of the liquid crystal display panel.

In one embodiment, a structure of the polymerization inhibitor functional group L is represented by one of

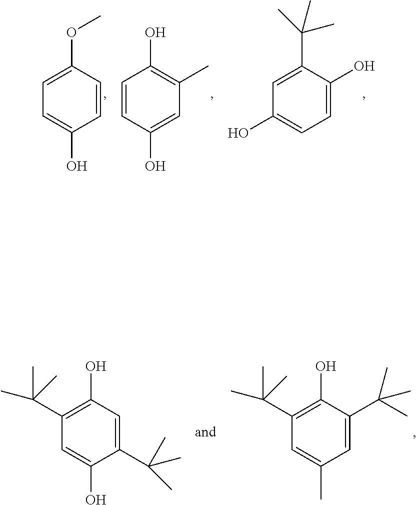

and a polymerization mechanism thereof is:

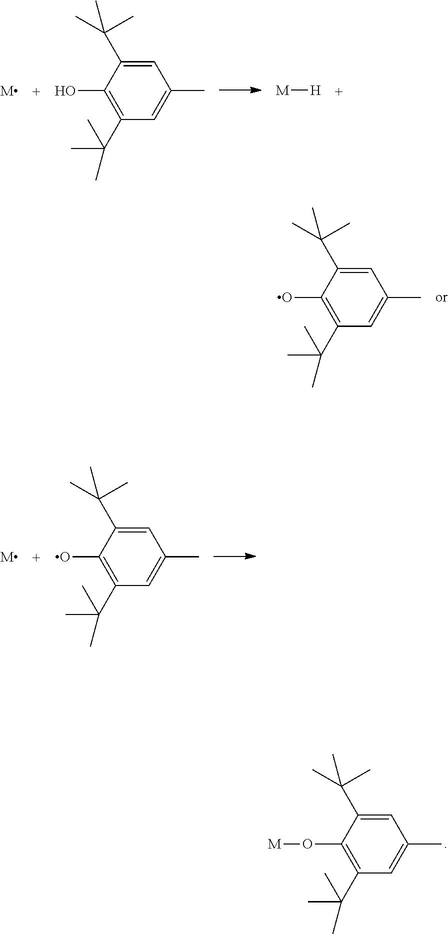

Thus, a structure of the vertical alignment agent 3 is one or more of following compounds:

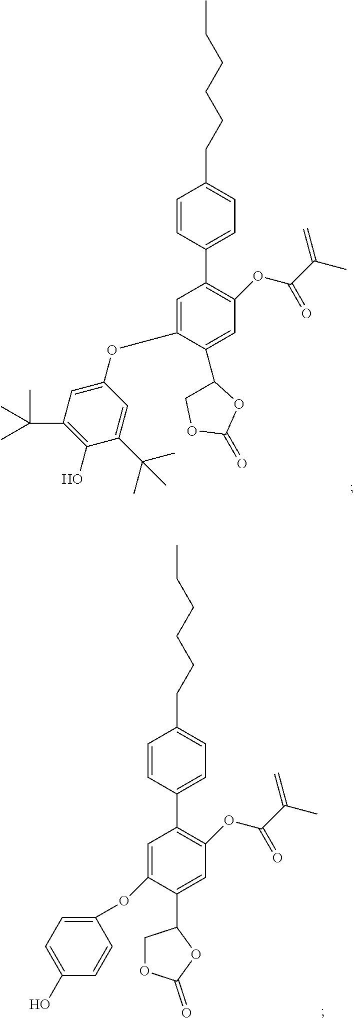 [SMILES: C=C(C)C(=O)Oc1cc(C2COC(=O)O2)c(Oc2cc(C(C)(C)C)c(O)c(C(C)(C)C)c2)cc1-c1ccc(CCCCCC)cc1 ; ";" ; C=C(C)C(=O)Oc1cc(C2COC(=O)O2)c(Oc2ccc(O)cc2)cc1-c1ccc(CCCCCC)cc1 ; ";"]

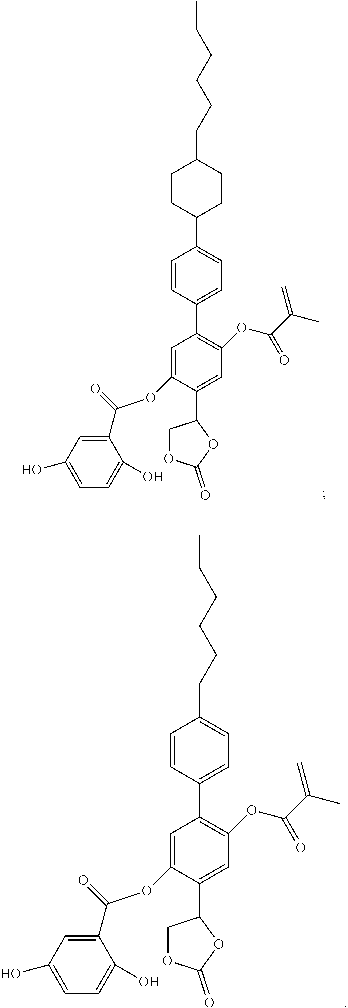

In the first embodiment of the present invention, a mass percentage relationship of the liquid crystal molecules 1, the active monomers 2 and the vertical alignment agent 3 is 0.2 to 0.5%:0.2 to 5.0%:94.5 to 99.6%. The alignment stability of the liquid crystal can be improved, and the phenomenon of light leakage in the dark state can be effectively avoided in the liquid crystal display panel.

Corresponding to the liquid crystal medium mixture provided in the first embodiment of the present invention, the second embodiment of the present invention further provides a liquid crystal display panel, comprising a thin film transistor array substrate, a color filter substrate and a liquid crystal layer configured between the thin film transistor array substrate and the color filter substrate, wherein the liquid crystal layer comprises a liquid crystal medium mixture in the first embodiment of the present invention. Because the liquid crystal medium mixture in the second embodiment of the present invention has the same structure and connection relationship with the liquid crystal medium mixture in the first embodiment of the present invention, the reference may be made to the related content of the liquid crystal medium mixture in the first embodiment of the present invention for detail, and will not be described repeatedly herein.

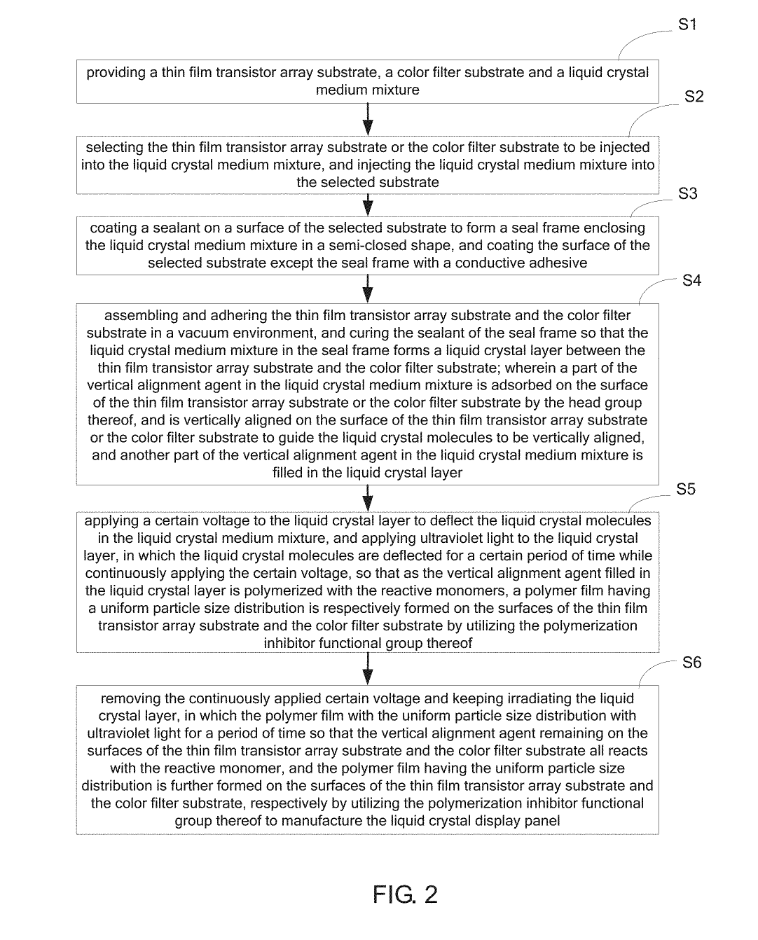

As shown in FIG. 2, which is the third embodiment of the present invention, providing a manufacturing method of a liquid crystal display panel, comprising:

Step S1, providing a thin film transistor array substrate, a color filter substrate and a liquid crystal medium mixture; wherein the liquid crystal medium mixture comprises liquid crystal molecules, reactive monomers and a vertical alignment agent, and the vertical alignment agent comprises a head group, a middle base group, a tail group, a polymeric group and a polymerization inhibitor functional group;

wherein a constitutional formula of the vertical alignment agent is one of

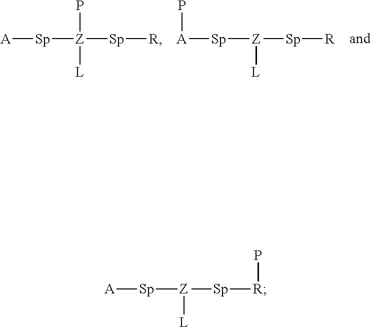

wherein

A refers to a head group for anchoring a surface of a substrate of the liquid crystal display panel to achieve vertical alignment of the liquid crystal molecules, and a structure thereof is represented as a composition containing a plurality of oxygen atoms;

Sp refers to a rigid link for guiding alignment of the liquid crystal molecules, and a structure thereof is represented as —(CH₂)i-, and i is 1 to 8: CH₂ of any one middle end of Sp can be replaced by —O—, —S—, —CO—, —CO—O—, —O—CO—, —O—CO—O—, —OCH₂—, —CH₂O—, —CH═CH—, —CF═CF—, —CH═CH—COO— or —OCO—CH═CH—;

Z refers to a middle base group for guiding arrangement of the liquid crystal molecules, and a structure thereof is represented as [A]m, and m is an integer larger than 1; wherein A is represented as a benzene ring or a cycloalkane, and one or more H atom of the benzene ring or the cycloalkane can be replaced by F, Cl, Br, I, —CN, —NO₂ or —C(═O)H;

R refers to a tail group for guiding arrangement of the liquid crystal molecules, and a structure thereof is represented as a linear or branched alkane having 5 to 20 C atoms; wherein any one CH₂ group of R can be replaced by a group of phenyl, cycloalkyl, —CONH—, —COO—, —O—CO—, —S—, —CO— or —CH═CH—, and the H atom can be replaced by a group of F or Cl;

P refers to a polymeric group that forms a film layer of polymer particles under irradiation of ultraviolet light so that the liquid crystal molecules have a pretilt angle, and a structure thereof is represented as an any combination of

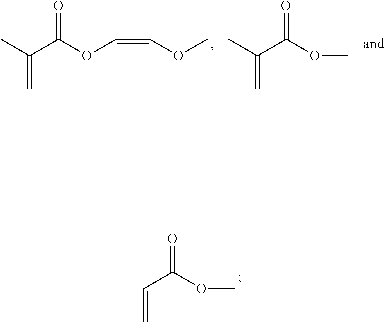

L refers to a polymerization inhibitor functional group for reducing an reactivity of the polymeric group P so that a size distribution of polymer particles formed under irradiation of ultraviolet light is uniform and for further enhancing an ability to anchor the surface of the substrate of the liquid crystal display panel, and a structure thereof is represented as phenol, and a specific constitutional formula is

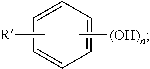

wherein n is 1 to 2; R′ is represented as a linear or branched alkane having 1 to 5 carbon atoms, wherein any one carbon atom of R′ can be replaced by —O—, —CO—, —COO— or —O—CO—;

Step S2, selecting the thin film transistor array substrate or the color filter substrate to be injected into the liquid crystal medium mixture, and injecting the liquid crystal medium mixture into the selected substrate;

Step S3, coating a sealant on a surface of the selected substrate to form a seal frame enclosing the liquid crystal medium mixture in a semi-closed shape, and coating the surface of the selected substrate except the seal frame with a conductive adhesive;

Step S4, assembling and adhering the thin film transistor array substrate and the color filter substrate in a vacuum environment, and curing the sealant of the seal frame so that the liquid crystal medium mixture in the seal frame forms a liquid crystal layer between the thin film transistor array substrate and the color filter substrate; wherein a part of the vertical alignment agent in the liquid crystal medium mixture is adsorbed on the surface of the thin film transistor array substrate or the color filter substrate by the head group thereof, and is vertically aligned on the surface of the thin film transistor array substrate or the color filter substrate to guide the liquid crystal molecules to be vertically aligned, and another part of the vertical alignment agent in the liquid crystal medium mixture is filled in the liquid crystal layer;

Step S5, applying a certain voltage to the liquid crystal layer to deflect the liquid crystal molecules in the liquid crystal medium mixture, and applying ultraviolet light to the liquid crystal layer, in which the liquid crystal molecules are deflected for a certain period of time while continuously applying the certain voltage, so that as the vertical alignment agent filled in the liquid crystal layer is polymerized with the reactive monomers, a polymer film having a uniform particle size distribution is respectively formed on the surfaces of the thin film transistor array substrate and the color filter substrate by utilizing the polymerization inhibitor functional group thereof;

Step S6, removing the continuously applied certain voltage and keeping irradiating the liquid crystal layer, in which the polymer film with the uniform particle size distribution with ultraviolet light for a period of time so that the vertical alignment agent remaining on the surfaces of the thin film transistor array substrate and the color filter substrate all reacts with the reactive monomer, and the polymer film having the uniform particle size distribution is further formed on the surfaces of the thin film transistor array substrate and the color filter substrate, respectively by utilizing the polymerization inhibitor functional group thereof to manufacture the liquid crystal display panel.

Specifically, in Step S1, the thin film transistor array substrate and the color filter substrate coated with a PI (polyimide) film, and a mass percentage relationship of the liquid crystal molecules, the active monomers and the vertical alignment agent is set to be 0.2 to 0.5%: 0.2 to 5.0%: 94.5 to 99.6%.

In Step S2, the thin film transistor array substrate or the color filter substrate is selected to be injected into the liquid crystal medium mixture, and the liquid crystal medium mixture having the aforesaid mass percentage relationship is injected into the selected substrate by ODF (one drop filling) process.

In Step S3, the sealant is coated on the surface of the selected substrate to form the seal frame in a semi-closed shape. The region in the seal frame is filled with the liquid crystal medium mixture. Meanwhile, the surface of the selected substrate outside the seal frame is coated with the conductive adhesive for ensuring the conductive performance of the thin film transistor array substrate and the color filter substrate after the assembly.

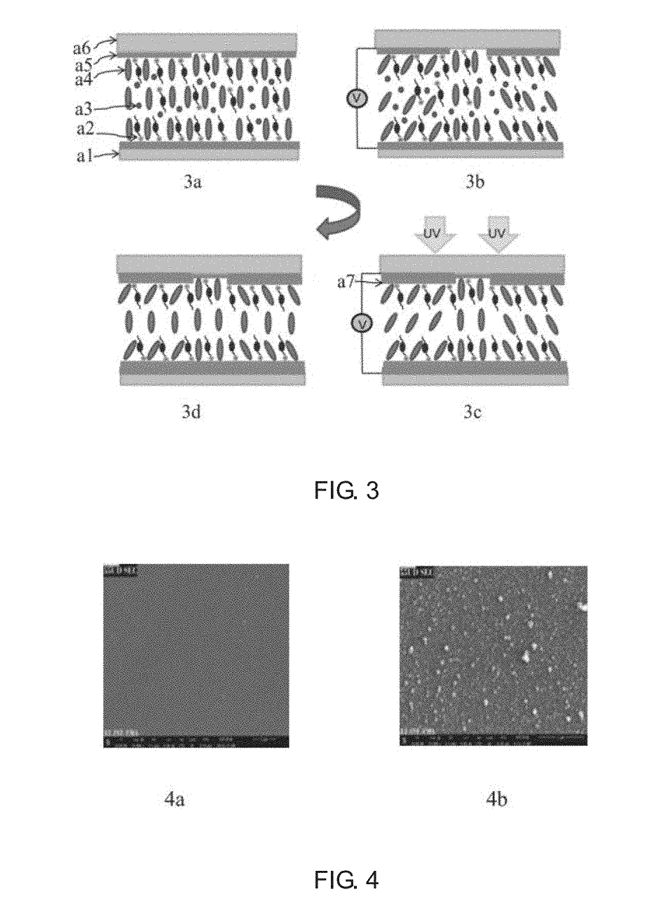

In Step S4, the thin film transistor array substrate and the color filter substrate are adhered, together in a vacuum environment, and the sealant is cured. The curing method adopts the thermal curing or the UV curing to obtain the liquid crystal layer disposed between the thin film transistor array substrate and the color filter substrate. Significantly, a part of the vertical alignment agent is adsorbed on the surface of the thin film transistor array substrate or the color filter substrate by the head group thereof, and is vertically aligned on the surface of the thin film transistor array substrate or the color filter substrate to guide the liquid crystal molecules to be vertically aligned, and another part of the vertical alignment agent is filled in the liquid crystal layer as shown with 3a in FIG. 3.

In Step S5, the voltage applied to the liquid crystal layer is 13 to 25V to deflect the liquid crystal molecules as shown with 3b in FIG. 3. Meanwhile, the ultraviolet light of the intensity 85 to 100 mW/cm2 and the irradiation time 20 to 100 s is used to irradiate to the liquid crystal layer, in which the liquid crystal molecules are deflected while continuously applying the certain voltage so that as the vertical alignment agent filled in the liquid crystal layer is polymerized with the reactive monomers, the polymer film having the uniform particle size distribution is respectively formed on the surfaces of the thin film transistor array substrate and the color filter substrate by utilizing the polymerization inhibitor functional group thereof as shown with 3c in FIG. 3.

In Step S6, the continuously applied voltage of 13 to 25V is removed, and then the irradiation of the ultraviolet light to the liquid crystal layer is continued with 90 to 120 min (the intensity is 85 to 100 mW/cm2), so that the vertical alignment agent remaining on the surfaces of the thin film transistor array substrate and the color filter substrate all reacts with the reactive monomer, and the polymer film having the uniform particle size distribution is further formed on the surfaces of the thin film transistor array substrate and the color filter substrate, respectively by utilizing the polymerization inhibitor functional group thereof to manufacture the liquid crystal display panel as shown with 3d in FIG. 3.

In one embodiment, as the liquid crystal layer with an area size of 10*10 cm is prepared by the manufacturing method of the liquid crystal display panel in the third embodiment of the present invention, the structure, the amount and the orientation effect of the vertical alignment agent used in the liquid crystal molecules are compared as follows:

| | Amount (mass | |
|---|---|---|
| | percentage in | Vertical |
| Structure of vertical alignment agent | liquid crystal) | orientation effect |
| 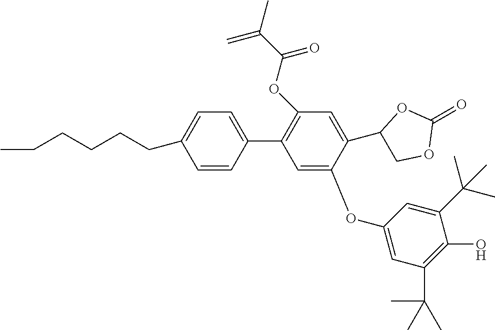 [SMILES: C=C(C)C(=O)Oc1cc(C2COC(=O)O2)c(Oc2cc(C(C)(C)C)c(O)c(C(C)(C)C)c2)cc1-c1ccc(CCCCCC)cc1] | 0.3% 1.0% | dark state with no light leakage dark state with no light leakage |
| 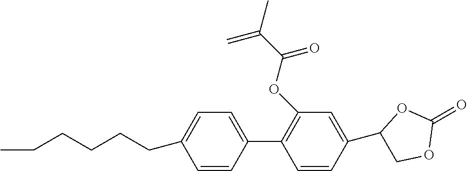 [SMILES: C=C(C)C(=O)Oc1cc(C2COC(=O)O2)ccc1-c1ccc(CCCCCC)cc1] | 0.3% 1.0% 2.0% | dark state with light leakage dark state with light leakage dark state with no light leakage |

In another embodiment, as the liquid crystal layer with an area size of 10*10 cm is prepared by the manufacturing method of the liquid crystal display panel in the third embodiment of the present invention, since the structure of the vertical alignment agent is

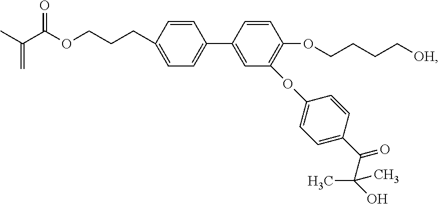 [SMILES: C=C(C)C(=O)OCCCc1ccc(-c2ccc(OCCCCO)c(Oc3ccc(C(=O)C(C)(C)O)cc3)c2)cc1]

and the structure comprises the polymerization inhibitor functional group, the polymer formed by the UV reaction in the liquid crystal layer is small and uniform as shown with 4a in FIG. 4; since the structure of the vertical alignment agent is

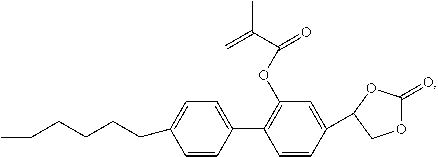 [SMILES: C=C(C)C(=O)Oc1cc(C2COC(=O)O2)ccc1-c1ccc(CCCCCC)cc1]

and the structure has no polymerization inhibitor functional group, the polymer formed by the UV reaction in the liquid crystal layer is large and non-uniform as shown with 4b in FIG. 4.

In conclusion, the implementation of the embodiment of the present invention possesses benefits: since the polymerization inhibitor functional group is used in the vertical alignment agent to reduce the reactivity of the polymeric group, the size distribution of the polymer particles formed by the polymerization under UV irradiation is uniform, and the anchoring force to the substrate surface of the liquid crystal display panel is reinforced. Thus, the alignment stability of the liquid crystal can be improved to avoid the phenomenon of light leakage in the dark state in the liquid crystal display panel to raise the reliability of the liquid crystal display panel.

Above are one of embodiments of the present invention, which does not limit the scope of the present invention. Any equivalent amendments within the spirit and principles of the embodiment described above should be covered by the protected scope of the invention.

What is claimed is:

1. A liquid crystal medium mixture, disposed in a liquid crystal layer of a liquid crystal display panel, wherein the liquid crystal medium mixture comprises liquid crystal molecules, reactive monomers and a vertical alignment agent, and the vertical alignment agent comprises a head group, a middle base group, a tail group, a polymeric group and a polymerization inhibitor functional group;
wherein a constitutional formula of the vertical alignment agent is one of 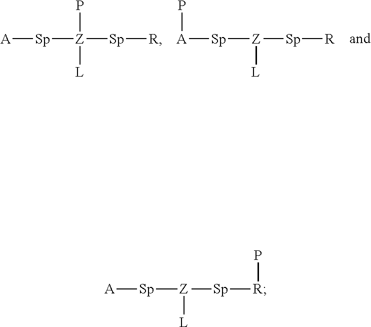
wherein
A refers to a head group for anchoring a surface of a substrate of the liquid crystal display panel to achieve vertical alignment of the liquid crystal molecules, and a structure thereof is represented as a composition containing a plurality of oxygen atoms;
Sp refers to a rigid link for guiding alignment of the liquid crystal molecules, and a structure thereof is represented as —(CH₂)i-, and i is 1 to 8; CH₂ of any one middle end of Sp can be replaced by —O—, —S—, —CO—, —CO—O—, —O—CO—, —O—CO—O—, —OCH₂—, —CH₂O—, —CH═CH—, —CF═CF—, —CH═CH—COO— or —OCO—CH═CH—;
Z refers to a middle base group for guiding arrangement of the liquid crystal molecules, and a structure thereof is represented as [A]m, and m is an integer larger than 1; wherein A is represented as a benzene ring or a cycloalkane, and one or more H atom of the benzene ring or the cycloalkane can be replaced by F, Cl, Br, I, —CN, —NO₂ or —C(═O)H;
R refers to a tail group for guiding arrangement of the liquid crystal molecules, and a structure thereof is represented as a linear or branched alkane having 5 to 20 C atoms; wherein any one CH₂ group of R can be replaced by a group of phenyl, cydoalkyl, —CONH—, —COO—, —O—CO—, —S—, —CO— or —CH═CH—, and the H atom can be replaced by a group of F or Cl;
P refers to a polymeric group that forms a film layer of polymer particles under irradiation of ultraviolet light so that the liquid crystal molecules have a pretilt angle, and a structure thereof is represented as an any combination of 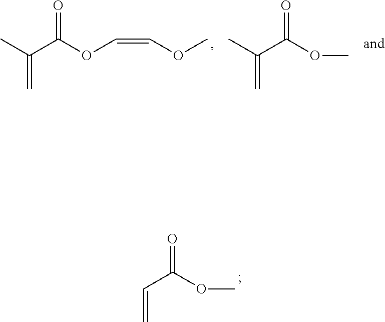
L refers to a polymerization inhibitor functional group for reducing an reactivity of the polymeric group P so that a size distribution of polymer particles formed under irradiation of ultraviolet light is uniform and for further enhancing an ability to anchor the surface of the substrate of the liquid crystal display panel, and a structure thereof is represented as phenol, and a specific constitutional formula is 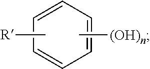
wherein n is 1 to 2; R′ is represented as a linear or branched alkane having 1 to 5 carbon atoms, wherein any one carbon atom of R′ can be replaced by —O—, —CO—, —COO— or —O—CO—.

2. The liquid crystal medium mixture according to claim 1, wherein a structure of the polymerization inhibitor functional group is represented by one of

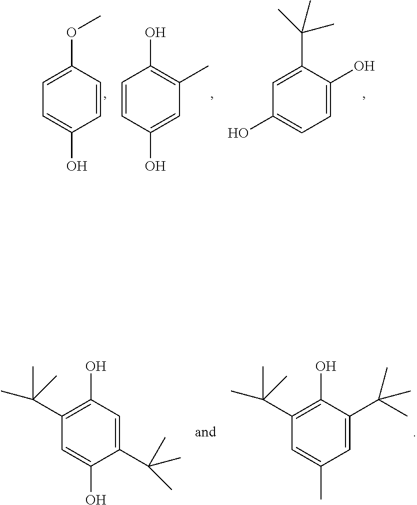

3. The liquid crystal medium mixture according to claim 1, wherein a mass percentage relationship of the liquid crystal molecules, the active monomers and the vertical alignment agent is 0.2 to 0.5%:0.2 to 5.0%:94.5 to 99.6%.

4. The liquid crystal medium mixture according to claim 1, wherein a structure of the vertical alignment agent is one or more of following compounds:

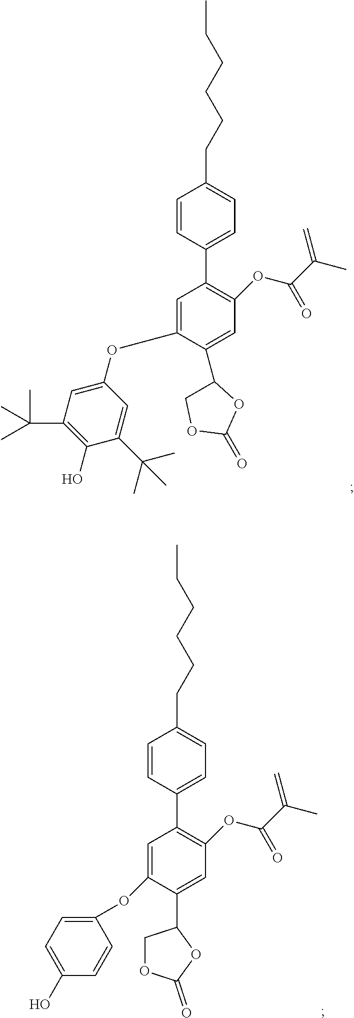 [SMILES: C=C(C)C(=O)Oc1cc(C2COC(=O)O2)c(Oc2cc(C(C)(C)C)c(O)c(C(C)(C)C)c2)cc1-c1ccc(CCCCCC)cc1 ; ";" ; C=C(C)C(=O)Oc1cc(C2COC(=O)O2)c(Oc2ccc(O)cc2)cc1-c1ccc(CCCCCC)cc1 ; ";"]

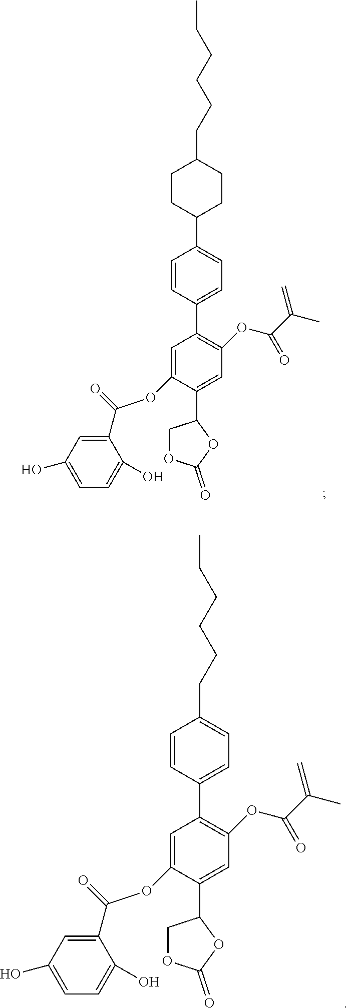

5. A liquid crystal display panel, comprising a thin film transistor array substrate, a color filter substrate and a liquid crystal layer configured between the thin film transistor array substrate and the color filter substrate, wherein the liquid crystal layer comprises a liquid crystal medium mixture;
the liquid crystal medium mixture comprises liquid crystal molecules, reactive monomers and a vertical alignment agent, and the vertical alignment agent comprises a head group, a middle base group, a tail group, a polymeric group and a polymerization inhibitor functional group;
wherein a constitutional formula of the vertical alignment agent is one of 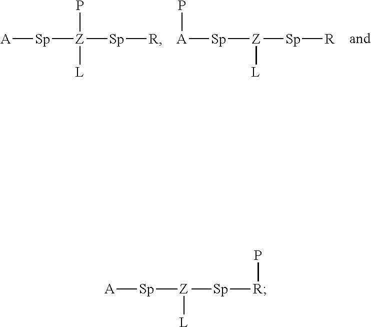
wherein
A refers to a head group for anchoring a surface of a substrate of the liquid crystal display panel to achieve vertical alignment of the liquid crystal molecules, and a structure thereof is represented as a composition containing a plurality of oxygen atoms;
Sp refers to a rigid link for guiding alignment of the liquid crystal molecules, and a structure thereof is represented as —(CH₂)i-, and i is 1 to 8; CH₂ of any one middle end of Sp can be replaced by —O—, —S—, —CO—, —CO—O—, —O—CO—, —O—CO—O—, —OCH₂—, —CH₂O—, —CH═CH—, —CF═CF—, —CH═CH—COO— or —OCO—CH═CH—;
Z refers to a middle base group for guiding arrangement of the liquid crystal molecules, and a structure thereof is represented as [A]m, and m is an integer larger than 1; wherein A is represented as a benzene ring or a cycloalkane, and one or more H atom of the benzene ring or the cycloalkane can be replaced by F, Cl, Br, I, —CN, —NO₂ or —C(═O)H;
R refers to a tail group for guiding arrangement of the liquid crystal molecules, and a structure thereof is represented as a linear or branched alkane having 5 to 20 C atoms; wherein any one CH₂ group of R can be replaced by a group of phenyl, cycloalkyl, —CONH—, —COO—, —O—CO—, —S—, —CO— or —CH═CH—, and the H atom can be replaced by a group of F or Cl;
P refers to a polymeric group that forms a film layer of polymer particles under irradiation of ultraviolet light so that the liquid crystal molecules have a pretilt angle, and a structure thereof is represented as an any combination of 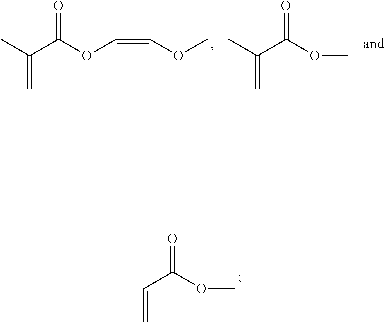
L refers to a polymerization inhibitor functional group for reducing an reactivity of the polymeric group P so that a size distribution of polymer particles formed under irradiation of ultraviolet light is uniform and for further enhancing an ability to anchor the surface of the substrate of the liquid crystal display panel, and a structure thereof is represented as phenol, and a specific constitutional formula is 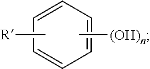
wherein n is 1 to 2; R′ is represented as a linear or branched alkane having 1 to 5 carbon atoms, wherein any one carbon atom of R′ can be replaced by —O—, —CO—, —COO— or —O—CO—.

6. The liquid crystal display panel according to claim 5, wherein a structure of the polymerization inhibitor functional group is represented by one of

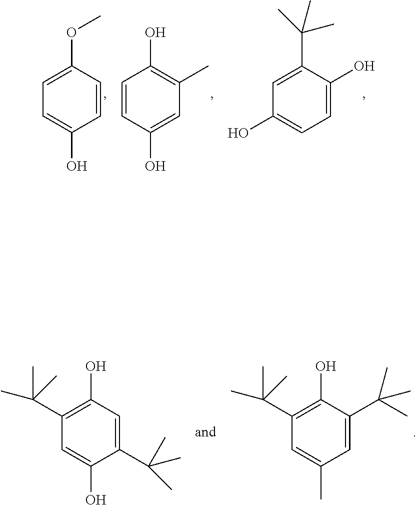

7. The liquid crystal display panel according to claim 5, wherein a mass percentage relationship of the liquid crystal molecules, the active monomers and the vertical alignment agent is 0.2 to 0.5%:0.2 to 5.0%:94.5 to 99.6%.

8. The liquid crystal display panel according to claim 5, wherein a structure of the vertical alignment agent is one or more of following compounds:

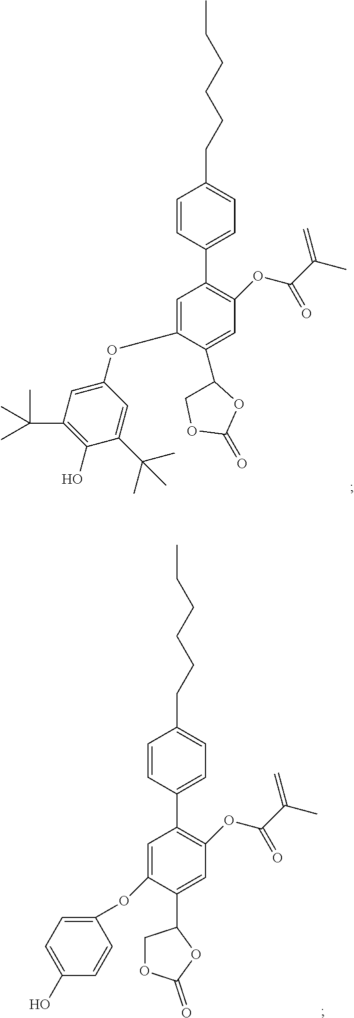 [SMILES: C=C(C)C(=O)Oc1cc(C2COC(=O)O2)c(Oc2cc(C(C)(C)C)c(O)c(C(C)(C)C)c2)cc1-c1ccc(CCCCCC)cc1 ; ";" ; C=C(C)C(=O)Oc1cc(C2COC(=O)O2)c(Oc2ccc(O)cc2)cc1-c1ccc(CCCCCC)cc1 ; ";"]

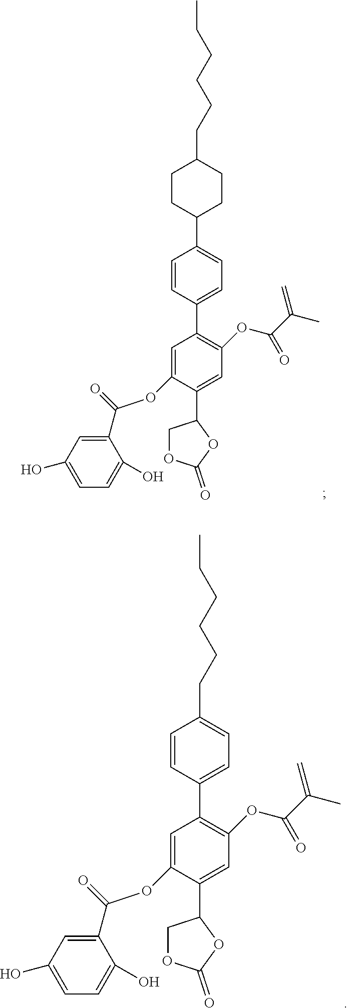

9. A manufacturing method of a liquid crystal display panel, comprising:
Step S1, providing a thin film transistor array substrate, a color filter substrate and a liquid crystal medium mixture; wherein the liquid crystal medium mixture comprises liquid crystal molecules, reactive monomers and a vertical alignment agent, and the vertical alignment agent comprises a head group, a middle base group, a tail group, a polymeric group and a polymerization inhibitor functional group;
wherein a constitutional formula of the vertical alignment agent is one of 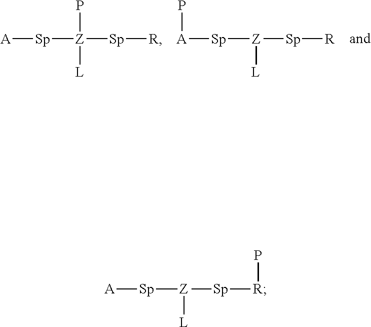
wherein
A refers to a head group for anchoring a surface of a substrate of the liquid crystal display panel to achieve vertical alignment of the liquid crystal molecules, and a structure thereof is represented as a composition containing a plurality of oxygen atoms;
Sp refers to a rigid link for guiding alignment of the liquid crystal molecules, and a structure thereof is represented as —(CH₂)i-, and i is 1 to 8; CH₂ of any one middle end of Sp can be replaced by —O—, —S—, —CO—, —CO—O—, —O—CO—, —O—CO—O—, —OCH₂—, —CH₂O—, —CH═CH—, —CF═CF—, —CH═CH—COO— or —OCO—CH═CH—;
Z refers to a middle base group for guiding arrangement of the liquid crystal molecules, and a structure thereof is represented as [A]m, and m is an integer larger than 1; wherein A is represented as a benzene ring or a cycloalkane, and one or more H atom of the benzene ring or the cycloalkane can be replaced by F, Cl, Br, I, —CN, —NO₂ or —C(═O)H;
R refers to a tail group for guiding arrangement of the liquid crystal molecules, and a structure thereof is represented as a linear or branched alkane having 5 to 20 C atoms; wherein any one CH₂ group of R can be replaced by a group of phenyl, cycloalkyl, —CONH—, —COO—, —O—CO—, —S—, —CO— or —CH═CH—, and the H atom can be replaced by a group of F or Cl;
P refers to a polymeric group that forms a film layer of polymer particles under irradiation of ultraviolet light so that the liquid crystal molecules have a pretilt angle, and a structure thereof is represented as an any combination of 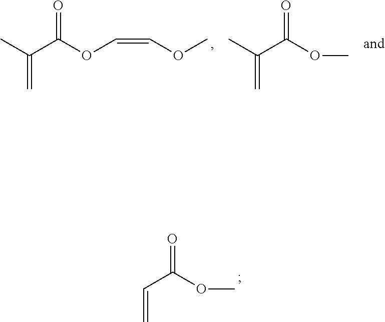
L refers to a polymerization inhibitor functional group for reducing an reactivity of the polymeric group P so that a size distribution of polymer particles formed under irradiation of ultraviolet light is uniform and for further enhancing an ability to anchor the surface of the substrate of the liquid crystal display panel, and a structure thereof is represented as phenol, and a specific constitutional formula is 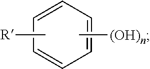
wherein n is 1 to 2; R′ is represented as a linear or branched alkane having 1 to 5 carbon atoms, wherein any one carbon atom of R′ can be replaced by —O—, —CO—, —COO— or —O—CO—;
Step S2, selecting the thin film transistor array substrate or the color filter substrate to be injected into the liquid crystal medium mixture, and injecting the liquid crystal medium mixture into the selected substrate;
Step S3, coating a sealant on a surface of the selected substrate to form a seal frame enclosing the liquid crystal medium mixture in a semi-closed shape, and coating the surface of the selected substrate except the seal frame with a conductive adhesive;
Step S4, assembling and adhering the thin film transistor array substrate and the color filter substrate in a vacuum environment, and curing the sealant of the seal frame so that the liquid crystal medium mixture in the seal frame forms a liquid crystal layer between the thin film transistor array substrate and the color filter substrate; wherein a part of the vertical alignment agent in the liquid crystal medium mixture is adsorbed on the surface of the thin film transistor array substrate or the color filter substrate by the head group thereof, and is vertically aligned on the surface of the thin film transistor array substrate or the color filter substrate to guide the liquid crystal molecules to be vertically aligned, and another part of the vertical alignment agent in the liquid crystal medium mixture is filled in the liquid crystal layer,
Step S5, applying a certain voltage to the liquid crystal layer to deflect the liquid crystal molecules in the liquid crystal medium mixture, and applying ultraviolet light to the liquid crystal layer, in which the liquid crystal molecules are deflected for a certain period of time while continuously applying the certain voltage, so that as the vertical alignment agent filled in the liquid crystal layer is polymerized with the reactive monomers, a polymer film having a uniform particle size distribution is respectively formed on the surfaces of the thin film transistor array substrate and the color filter substrate by utilizing the polymerization inhibitor functional group thereof;
Step S6, removing the continuously applied certain voltage and keeping irradiating the liquid crystal layer, in which the polymer film with the uniform particle size distribution with ultraviolet light for a period of time so that the vertical alignment agent remaining on the surfaces of the thin film transistor array substrate and the color filter substrate all reacts with the reactive monomer, and the polymer film having the uniform particle size distribution is further formed on the surfaces of the thin film transistor array substrate and the color filter substrate, respectively by utilizing the polymerization inhibitor functional group thereof to manufacture the liquid crystal display panel.

10. The manufacturing method of the liquid crystal display panel according to claim 9, wherein in Step S1, a mass percentage relationship of the liquid crystal molecules, the active monomers and the vertical alignment agent is 0.2 to 0.5%:0.2 to 5.0%:94.5 to 99.6%.

11. The manufacturing method of the liquid crystal display panel according to claim 10, wherein in Step S4, a thermal curing or an ultraviolet irradiation curing is implemented to the sealant of the seal frame.

12. The manufacturing method of the liquid crystal display panel according to claim 11, wherein in Step S5, the voltage applied to the liquid crystal layer is 13 to 25V, and an intensity of ultraviolet irradiation used is 85 to 100 mW/cm2, and an irradiation time is 20 to 100 s.

13. The manufacturing method of the liquid crystal display panel according to claim 12, wherein in Step S6, the period of time for the ultraviolet irradiation is 90 to 120 min.
